(19) United States
(12) Patent Application Publication
(10) Pub. No.: US 2025/0267426 A1
(43) Pub. Date: Aug. 21, 2025

(54) LOCATION TRACKING METHOD AND SYSTEM

(71) Applicant: Holy Spirit University of Kaslik, New York, NY (US)

(72) Inventor: Badih BAZ, Jounieh (LB)

(73) Assignee: Holy Spirit University of Kaslik, New York, NY (US)

(21) Appl. No.: 18/443,020

(22) Filed: Feb. 15, 2024

(51) Int. Cl. H04W 4/021; H04W 4/029; H04W 12/06

(52) U.S. Cl. CPC H04W 4/021; H04W 4/029; H04W 12/06

(57) ABSTRACT

A method for tracking a person's location with a system that keeps track of the location of a person in or at a facility that includes a server configured to communicate with at least one mobile device associated with a person and at least one short-range radio transceiver located in the facility, the mobile device being configured to transmit its geolocation to the server, configured to communicate with the short-range radio transceiver, and configured to perform biometric identification, and the server being configured to locate the person in the facility based on the geolocation of the mobile device, biometric identification performed by the mobile device, and location of the short-range radio transceiver in communication with the mobile device.

### FIELD OF THE INVENTION

The present invention relates to a method for keeping track of the location of a person in or at a facility and a system for implementing the method.

### BACKGROUND OF THE INVENTION

Organizations that manage the activities of people (e.g. employees or students at a university) have a need for locating the people under management.

Currently, there are security system that can track the entry and exit of a person's security card into and out of a facility. Such a system cannot necessarily verify that the person associated with the security card in fact entered and exited the facility.

Furthermore, such systems can not normally locate the person within the facility or track the location of the person at a given location for a period of time.

### SUMMARY OF THE INVENTION

It is an object of the present invention to provide a method for keeping track of the location of an individual at facility such as a building.

It is another objection of the present invention to devise a system keeps track of the location of an individual at facility such as a building.

A method according to the present invention permits confirming the presence of an individual at a specific location in a facility for a period of time, even if the facility is a multi-level building.

A system according to the present invention is configured to track the location of a person or persons in a facility or a number of facilities.

A system according to the present invention includes a server configured to communicate with at least one mobile device associated with the person and at least one short-range radio transceiver located in a facility, the mobile device being configured to transmit its geolocation to the server, configured to communicate with the short-range radio transceiver, and configured to perform biometric identification, wherein the server is configured to locate the person in the facility based on the geolocation of the mobile device, biometric identification performed by the mobile device, and location of the short-range radio transceiver in communication with the mobile device.

The mobile device may be a smart phone, a laptop computer, or a tablet, the biometric identification may be performed with facial recognition, voice recognition, or finger print recognition, and the geolocation may be acquired from a global positioning system (GPS).

The system may further comprising at least one database server configured to record information acquired from the mobile device and the short-range radio transceiver.

The server may be configured to transmit instruction to the mobile device to generate an audio signal or an audio message indicating location of the mobile device in the facility.

The server may be configured to receive temperature and humidity information from the short-range radio transceiver and to trigger a fire alert based on the temperature and the humidity information.

The server may be configured to send a communication to the mobile device while the mobile device is in communication range with the short-range radio transceiver.

A method according to the present invention tracks the location of a person in or at a facility with a system according to the present invention, and includes receiving a message or signal indicating geolocation of the mobile device; receiving a first message or signal by the server indicating that the mobile device has communicated with the short-range radio transceiver; receiving temporally spaced second messages or signals from by the server each indicating that the mobile device has communicated with the short-range radio transceiver; receiving confirmation of biometric identification from the mobile device; based on the first message or signal and the second messages or signals, determining location of the mobile device; and causing recording of the determined locations of the mobile device in a database.

A method according to the present invention may be used to track the locations of multiple persons at or in multiple facilities.

The server may receive the first message or signal and/or the second messages or signals from the mobile device or the short-range radio transceiver.

The first message or signal and each of the second messages or signals may be associated with a respective date and a respective time (i.e. virtually date-stamped and time-stamped).

The second messages or signals may be temporally spaced randomly.

Multiple confirmations of biometric identification may be received by the server, and the multiple confirmations of biometric identification may be temporally spaced randomly.

The method may further include designating with the server the first message or signal as point of initial entry of the person into a location uniquely associated with the short-range radio transceiver, and designating with the server a last message or signal from the second messages or signals as the person's point of exit from the location.

The location is a room within a building, which may be a multi-floor building.

The system may be configured to only determine the location of the mobile device while the mobile device is within the facility. For example, the mobile device only transmits information to the server when the mobile device is within the facility.

The mobile device may be configured (i.e. may be programmable) to generate the first message or signal, and the second messages or signals periodically and may be configured (i.e. may be programmable) to generate confirmations of biometric identification randomly. For example, the mobile device may be configured to receive a selection to set how often the mobile device communicates with the short-range radio transceiver and the server, and to receive a selection to set the mobile device to randomly perform biometric identification.

Other features and advantages of the present invention will become apparent from the following description of the invention which refers to the accompanying drawings.

### BRIEF DESCRIPTION OF THE DRAWINGS

FIG. 1 schematically shows a system for implementing a method according to the present invention.

FIG. 2 schematically shows a system for implementing a method according to the present invention deployed in a facility.

FIG. 3 shows an example of rights and privileges of users of an embodiment of a system according to the present invention.

### DETAILED DESCRIPTION OF EMBODIMENTS OF THE INVENTION

A method according to the present invention enables locating a person within a facility.

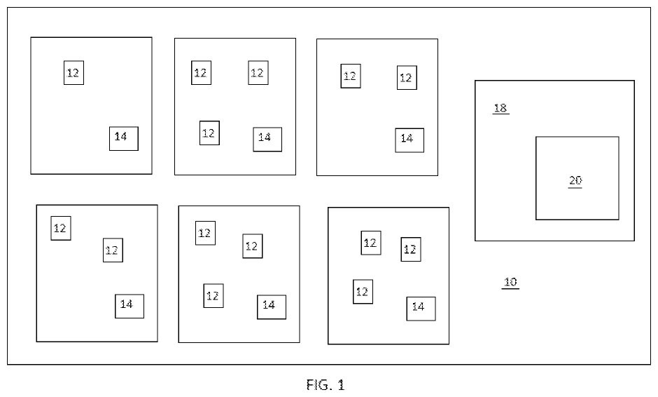

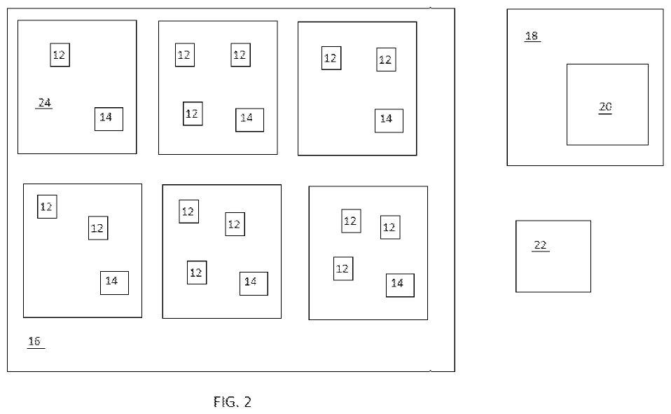

Referring to FIGS. 1 and 2, a method according to the present invention can be implemented with a system 10 that includes at least one mobile device 12 associated with a person, a plurality of external short-range radio transceivers 14 (i.e. outside of the mobile device) arranged at different locations within or around a facility 16, and a server facility 18 configured to communicate with the at least one mobile device 12 and the plurality of short-range radio transceivers 14 via a network of computers, for example, the Internet.

Short-range as used herein refers to a communication range that is no more than 400 meters, is preferably less than 100 meters, and in the case of small spaces within the facility such as offices or conference rooms no more than 10 meters.

The system 10 may include a plurality of mobile devices 12 each associated with a respective person, and the server facility 18 is configured to communicate with each mobile device 12 so that a number of people may be located within the facility 18.

The server facility 18 may include a server 20 configured to communicate with the mobile device(s) 12 and the short-range radio transceivers 14. A server as used herein means at least one server or a plurality of servers.

The server 20 may be configured to communicate with at least one database server 22 in order to record information acquired from the mobile device(s) 12 and the short-range radio transceivers 14.

A method according to the present invention uses three different input variables in order to establish the location of a person within the facility 16.

The first variable indicates the geographic location of a mobile device 12 associated with the person, which identifies the geographic location of the facility 16, where the mobile device 12 is located.

The second variable indicates the location of the mobile device 12 within the facility 16.

The third variable indicates the relative position of the person to the mobile device 12.

The mobile device 12 may be a smart phone, a laptop computer, a tablet, or the like mobile device 12 that has a processor and a non-transitory storage that can store computer-readable information that is readable by the processor, and computer-executable code that can be executed by the processor.

The computer-executable code enables biometric identification, for example, facial recognition, voice recognition, or finger print recognition.

The mobile device 12 is also configured (programmed) by computer-executable code to identify its geographic location. For example, the mobile device 12 may be configured to identify its location using a global positioning system (GPS).

The mobile device 12 also has a short-range radio transceiver 14, for example, a Bluetooth transceiver that can communicate with an external short-range radio transceiver 14, for example, a Bluetooth transceiver. The mobile device 12 is configured (programmed) by computer-executable code to transmit information to and receive information from the external short-range radio transmitter. In a method according to the present invention, the mobile device 12 is configured (programmed) to communicate (i.e. to receive information from and send information to) with the external short-range transceivers each located at a respective unique location within the facility 16.

In a method according to the present invention, when the mobile device 12 enters the facility 16, the server 20 receives a signal or a message from the mobile device 12 reporting the geographic location of the mobile device 12. The signal or message may indicate the geographic location of the mobile device 12 according to the GPS. The signal or message so received indicates the facility 16 in which the mobile device 12 has entered. The signal or massage may further have information indicating the date and the time of the entry of the mobile device 12 into the facility 16.

Once the mobile device 12 enters a unique location within the facility 16 (for example, a conference room 24) the mobile device 12 and the external short-range transceiver 14 associated with the unique location communicate, and a message or a signal is send to the server 20 indicating that the mobile device 12 has entered the unique location. The signal or message may be sent to the server 20 by the mobile device 12 or by the external short-ranger transceiver 14, and may also indicate the date and the time of the entry into the unique location within the facility 16. The server 20 may be able to identify the location of the external short-range transceiver 14 based on a unique serial number or some other unique identifier associated with the external short-range transceiver 14 which is sent along with the message or signal. The unique serial number or identifier may be stored in a database in association with the location of the external short-range transceiver 14 within the facility. The server 20 may receive and use the information so stored to determine the location of the external short-range transceiver 14.

According to the present invention, the mobile device 12 and the external short-range transceiver 14 at the unique location periodically and preferably randomly continue to communicate. A signal or message is then sent to the server 20 by the mobile device 12 or by the external short-range transceiver 14 every time there is a communication after the first communication, which together indicate the continued presence of the mobile device 12 within the communication range of the external short-range radio transceiver 14 over a period of time. The last signal or message may indicate the date and the time the mobile device 12 left the unique location within the facility 16. Thus, the first and the last signal or message can indicate when the mobile device 12 entered the unique location and when the mobile device 12 left the unique location within the facility 16, while the remaining signals and messages indicate the continued presence of the mobile device 12 at the unique location.

Advantageously, the short-range radio transceivers 14 can provide information about unique locations within the facility 16, which cannot be acquired from the geographic location of the mobile device 12. Thus, rooms at different locations (different floors even) can be identified by using short-range radio transceivers 14 within the facility 16.

The information indicating the geographic location of the mobile device 12 (e.g. GPS information), and the information provided regarding the communication between the mobile device 12 and a short-range radio transceiver 14 cannot indicate that the person associated with the mobile device 12 was present within the communication range of the mobile device 12 and the external short-range radio transceiver 14. Thus, that information cannot confirm that the person was at the unique location associated with the short-range radio transceiver 14. For example, the person could enter the unique location, leave the mobile device 12 at the unique location, and exit the unique location. Also, for example, a person other than the person associated with the mobile device 12 could carry the mobile device 12 into the unique location. To address this issue, the mobile device 12 is configured (programmed) to periodically, and preferably at random intervals, solicit biometric confirmation that the mobile device 12 is within reach of the person associated with the mobile device 12. For example, the mobile device 12 may generate an audio signal generated by the mobile device's speaker, a visual signal displayed by the mobile device's display monitor, or a sensory signal (e.g. vibration) prompting a person to provide biometric information to the mobile device 12. The biometric information may be a picture of the person's face taken by the mobile device's camera, a finger print image, or a voice sample, all of which may be dated and time-stamped by the mobile device 12. The mobile device 12 is also configured (programmed) to determine whether the provided biometric information indicates that it was the person associated with the mobile device 12 who provided the information. If so, a signal or a message is sent by the mobile device 12 or the short-range radio transceiver 14 indicating that the biometric information indicates that the information was provided by the person associated with the mobile device 12. If not, a signal or a message is sent by the mobile device 12 or the short-range radio transceiver 14 indicating that the provided biometric information does not indicate that the information was provided by the person associated with the mobile device 12. The signal or message so sent may also include the time and the date the biometric information was received by the mobile device 12.

In a method according to the second embodiment, the geographic location of the facility 16 is not acquired by the mobile device 12 and transmitted to the server 20. Rather, each external short-range radio transceiver 14 is associated with the geographic location of the facility 16. The geographic location of an external short-range radio transceiver 14 may be transmitted to the server 20 the first time the short-range radio transceiver 14 transmits a signal or a message to the server 20, or every time this event occurs. Alternatively, each short-range radio transceiver 14 may transmit a code (like a serial number) unique to the short-range radio transceiver 14, which is associated at the server facility 18 with the geographic location of the short-range radio transceiver 14.

In a method according to the present invention, all signals and messages received by the service are sent to the database server for recordation.

The external transceivers 14 may be Bluetooth beacons. A Bluetooth beacon is a small, wireless device that uses Bluetooth Low Energy (BLE) technology to transmit signals to nearby smartphones, tablets, or other compatible devices, and may have temperature and humidity sensors, optionally.

The following are the specification of a Bluetooth transceiver suitable for use with a system according to the present invention:

Model Number: BT003

Dimensions: 72*45*26 mm (L*W*H) Operating temperature: −40°′-85° C. Wireless Standards: Bluetooth 4.2/5.0, ANT Frequency Range: 2400 MHz - - - 2483.5 MHz Battery model: Size AA

Optional (BT003TLM):

Humidity sensor: 0% RH′-100%RH(±%2RH) Temperature sensor: −20° C.′-70° C. (±0.2° C.)

In order to configure (program) a mobile device for a system according to the present invention, a mobile app may be downloaded from an online app store to the mobile device. A PWA (progressive web app), is the back office of the system and may be used to configure a mobile device 12 to function as described herein. Mobile apps are designed to run on mobile devices whereas PWAs are designed to work across different browsers and platforms including mobile devices and desktops.

A system according to the present invention may be partially or fully implemented on the cloud. For example, the server 20 and the database server 22 may be provided by an online Cloud service, which would involve storing and processing data on remote servers, providing benefits such as scalability, accessibility, and reducing infrastructure management overhead.

As further explained below, the system has all of the following functionalities:
1—Real-Time Monitoring (Online system)
2—Remote online attendance (Working from home)
3—Onsite/offsite attendance (client visit, traveling or delivery)
4—Daily detailed activities sub-attendance (Accessing the warehouse/Attending an in-house conference or a meeting/student's class attendance)
5—Tasks that need physical presence (Cleaning hotel rooms)
6—Flexible Scheduling and Working Hours (Hospital employees, Security personnel)
7—Online Time and tasks management system
8—Security and Access Control: Users and groups access control and privileges
9—Data Analytics and Reporting

A system according to the present invention can be implemented in small, medium and large organizations, international organizations with sites in different countries.

A system according to the present invention may be implemented with IOS and ANDROID mobile devices and on any internet connected device

A system according to the present invention can be integrated with an Enterprise Resource Planning (ERP) and HR (Human Resources) systems by using middle tables or APIs (Application Programming Interface)

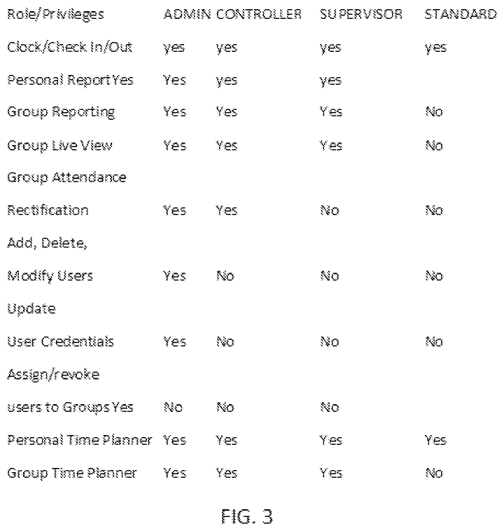

Referring to FIG. 3, in a system according to the present invention each user may have one of four roles, namely administrator, controller, supervisor, and non-administrator (standard).

An administrator can manage all supervisors, controllers, and standard users.

A controller can control and supervise all users belonging to his/her group.

A supervisor can supervise all standard users under his/her supervision.

A system according to the present invention may be provided with enterprise features. The enterprise features allow for the assignment of users that can be managed by an administrator, a controller, or a supervisor. The Groups are similar to departments or business functions. Each Group can contain a list of users. One user can be in one or more groups.

A system according to the present invention may be provided with a portal to permit its users access to the information that is collected and recorded in the database server 22. For example, employees of an organization using a system according to the present invention can at any time check their daily and monthly clocking reports. Similarly, an administrator can, using the information collected by the system, assign flexible scheduling which support cross-day timing for the employees.

A system according to the present invention can support two types of attendance, CLOCK and CHECK. The Clock attendance is the main attendance module, which tracks each employee's attendance at the employee's usual place of work (e.g. the employee's office). The Check attendance can be used as a sub-attendance used for off-site attendance, attending an in-house or external seminar-conference or a business trip/visit, for example.

An administrator can enable off-site attendance globally or for a specific group of users. During the off-site attendance, a system according to the present invention may record in the database server 22 the name of the person, the date/time, and the attendance geolocation coordinates. At any time, the administrator can check the above-mentioned data and view them on, for example, Apple Maps or Google Maps.

A system according to the present invention may be provided with an administrator web back office, which is a web-enabled system restricted to the administrator(s). The administrator web back office has two main modules, the live streaming attendance activities and the attendance reporting system. The administrator web back office can be used on any desktop or mobile phone running on any operating system (windows, mac, android, or iOS).

With a system according to the present invention, all information may be collected in real time and synchronized.

Furthermore, a system according to the present invention may be configured to permit an administrator to view all online activities, instantly generate summarized or detailed reports, monitor all activities in all branches, rectify mistakes or missed attendances, update user profiles, verify type and level, and review and monitor daily work schedules of the employees.

A non-administrator user of a system according to the present invention can Clock In/Clock Out-Check In/Check Out; monitor his/her daily activities; monitor monthly activities report, and manage his/her daily work schedule.

A system according to the present invention may be configured to scan all external transceivers at all facilities to determine who is present in the facility.

A system according to the present invention may be provided with a time planner module to permit the scheduling of tasks, and adding daily work details to share with the administrator, the controller and supervisors. The time planner module can provide a complete view and duration of tasks for the work-load of an entire week for each employee, for example. The time planner module can be automatically integrated with enterprise features to permit the administrator, the controller and/or the supervisor access to the system, with for example a mobile device to, for example, check the schedule of any full time or part time employee.

A system according to the present invention may be provided with enterprise features. The enterprise features allow for the assignment of users to GROUPs that can be managed by an administrator, a controller, or a supervisor. The Groups are similar to departments or business functions. Each Group can contain a list of users. One user can be in one or more groups.

FIG. 3 shows an example of the rights of each user within a system according to the present invention.

A system according to the present invention may further have:
1—Privacy & Geofencing, which restricts the system to only start tracking when an employee enters a specific geolocation area to protect the employee's privacy
2—Security & Auto-Attendance to automatically update a log file upon Phone/beacon detection
3—Visual impairment & Blind persons notification by triggering, at each Bluetooth beacon, a special beep, or a preprogrammed location voice message on the user's mobile device (e.g. “you are now in the main conference room” or “you are now in the Lobby”)
4—One click SOS (emergency) mobile device locator, to locate the exact location of the mobile device within the facility (office and/or floor etc.)
5—Beacon sensors for temperature and humidity that can be used to trigger a fire alert even in remote locations
6—Broadcast Communication for users to a specific beacon within a specific location.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system configured to keep track of location of a person in or at a facility, comprising a server configured to communicate with at least one mobile device associated with the person and at least one short-range radio transceiver located in the facility, the mobile device being configured to transmit its geolocation to the server, configured to communicate with the short-range radio transceiver, and configured to perform biometric identification, wherein the server is configured to locate the person in the facility based on the geolocation of the mobile device, biometric identification performed by the mobile device, and location of the short-range radio transceiver in communication with the mobile device.

2. The system of claim 1, further comprising at least one database server configured to record information acquired from the mobile device and the short-range radio transceiver.

3. The system of claim 1, wherein the mobile device is a smart phone, a laptop computer, or a tablet.

4. The system of claim 1, wherein the biometric identification is performed with facial recognition, voice recognition, or finger print recognition.

5. The system of claim 1, wherein the geolocation is acquired from a global positioning system (GPS).

6. The system of claim 1, wherein the server is configured to transmit instruction to the mobile device to generate an audio signal or an audio message indicating location of the mobile device in the facility.

7. The system of claim 1, wherein the server is configured to receive temperature and humidity information from the short-range radio transceiver and to trigger a fire alert based on the temperature and the humidity information.

8. The system of claim 1, wherein the server is configured to send a communication to the mobile device while the mobile device is in communication range with the short-range radio transceiver.

9. A method for keeping track of the location of a person in or at a facility with a system, the system comprising a server configured to communicate with at least one mobile device associated with the person and at least one short-range radio transceiver located in the facility, the mobile device being configured to transmit its geolocation to the server, configured to communicate with the short-range radio transceiver, and configured to perform biometric identification, wherein the server is configured to locate the person within the facility based on the geolocation of the mobile device, biometric identification performed by the mobile device, and location of the short-range radio transceiver in communication with the mobile device, and the method comprising:
receiving a message or signal indicating geolocation of the mobile device;
receiving a first message or signal by the server indicating that the mobile device has communicated with the short-range radio transceiver;
receiving temporally spaced second messages or signals from by the server each indicating that the mobile device has communicated with the short-range radio transceiver;
receiving confirmation of biometric identification from the mobile device;
based on the first message or signal and the second messages or signals, determining location of the mobile device; and
causing recording of the determined locations of the mobile device in a database.

10. The method of claim 9, wherein the server receives the first message or signal and/or the second messages or signals from the mobile device or the short-range radio transceiver.

11. The method of claim 9, wherein the first message or signal and each of the second messages or signals are associated with a respective date and a respective time.

12. The method of claim 9, wherein the second messages or signals are temporally spaced randomly.

13. The method of claim 9, wherein multiple confirmations of biometric identification are received by the server, and wherein the multiple confirmations of biometric identification are temporally spaced randomly.

14. The method of claim 9, further comprising designating with the server the first message or signal as point of initial entry of the person into a location uniquely associated with the short-range radio transceiver, and designating with the server a last message or signal from the second messages or signals as the person's point of exit from the location.

15. The method of claim 14, wherein the location is a room within a building.

16. The method of claim 15, wherein the building is a multi-floor building.

17. The method of claim 9, wherein the system only determines the location of the mobile device while the mobile device is within the facility.

18. The method claim 9, wherein the mobile device may be configured to generate the first message or signal, and the second messages or signals periodically and may be configured to generate confirmations of biometric identification randomly.

19. The method of claim 9, wherein the system comprises additional short-range radio transceivers with the facility, and the mobile device is configured to communicate with the additional short-range radio transceivers.
